(19) United States
(12) Patent Application Publication
(10) Pub. No.: US 2017/0193929 A1
(43) Pub. Date: Jul. 6, 2017

(54) DRIVING METHOD AND DRIVING DEVICE OF LIQUID CRYSTAL PANEL

(71) Applicant: Shenzhen China Star Optoelectronics Technology Co., Ltd., Guangdong (CN)

(72) Inventors: Lixuan CHEN, Guangdong (CN); Chih-tsung KANG, Guangdong (CN)

(21) Appl. No.: 14/779,188

(22) PCT Filed: Aug. 11, 2015
(86) PCT No.: PCT/CN2015/086662

§ 371 Date: Sep. 22, 2015

(30) Foreign Application Priority Data
Jul. 23, 2015 (CN) 201510439411.5

(51) Int. Cl. G09G 3/36; G09G 3/20

(52) U.S. Cl. CPC G09G 3/3607; G09G 3/2003; G09G 2310/0218; G09G 2300/0452; G09G 2320/0673; G09G 2320/0247

(57) ABSTRACT

A driving method and a driving device of a liquid crystal panel, including driving a predetermined color sub-pixel of a liquid crystal panel in a unit of consecutive n frames, wherein n is an integer larger than 1, and a step of driving the color sub-pixel in n frames of any one unit includes: determining an original greyscale value of each color sub-pixel respectively in n frames, so as to acquire n original greyscale values with respect to each color sub-pixel; acquiring n actual greyscale values of each color sub-pixel according to at least one of n original greyscale values of each color sub-pixel, wherein the n actual greyscale values include a first group of actual greyscale values and a second group of actual greyscale values; taking one of the actual greyscale values of each color sub-pixel as the final greyscale value to drive each color sub-pixel in each frame.

### TECHNICAL FIELD

The present disclosure relates to a technical field of a liquid crystal display, and more particularly, to a driving method and a driving device of a liquid crystal panel.

### BACKGROUND ART

In recent years, a traditional Cathode Ray Tube (CRT) display is gradually replaced by a Liquid Crystal Display (LCD) as the LCD is advantageous in its small size, light weight, high display quality, and the like. A picture displayed by a liquid crystal panel in the liquid crystal display is constituted by a plurality of pixels arranged in arrays, each pixel is usually composed of sub-pixels displaying a respective color respectively, and a brightness displayed by each sub-pixel is determined together by the brightness of a backlight module of the liquid crystal display and a greyscale of the sub-pixel of the liquid crystal panel. In an existing driving method of the liquid crystal display, the most common method is: maintaining a fixed brightness by using the brightness of the backlight module; driving a liquid crystal in each sub-pixel of the liquid crystal panel to rotate by using a greyscale voltage of a different size respectively according to input image data, so as to determine light transmittance (i.e. brightness) of the respective sub-pixel through a rotation angle of a liquid crystal molecule, thus achieving a purpose of greyscale display and imaging.

With the development of liquid crystal display technique, a time-division driving technique is proposed in order to solve a color bias problem of the liquid crystal display. The so-called time-division driving technique drives a plurality of actual greyscale values of each sub-pixel in a liquid crystal panel obtained through a conversion on to a liquid crystal panel in sequence so as to display a plurality of frame pictures. However, when using such a driving method, a scenario where greyscale values of all sub-pixels in a liquid crystal panel are relatively large or relatively small might occur in a certain frame picture, thereby causing a liquid crystal panel to be too bright or too dark as a whole, thus resulting in flickering of a displayed picture.

### SUMMARY

In order to overcome a defect of the related art, an exemplary embodiment of the present disclosure provides a driving method and a driving device of a liquid crystal panel for solving a problem of flickering of a picture of the liquid crystal panel while reducing a color bias of the liquid crystal panel.

According to one aspect of an examplary embodiment of the predent disclosure, there is provided a driving method of a liquid crystal panel, characterized in: driving a predetermined color sub-pixel of a liquid crystal panel in a unit of consecutive n frames, wherein n is an integer larger than 1, and a step of driving a predetermined color sub-pixel in n frames of any one unit includes: (A) determining an original greyscale value of each predetermined color sub-pixel respectively in n frames, so as to acquire n original greyscale values with respect to each predetermined color sub-pixel; (B) acquiring n actual greyscale values of each predetermined color sub-pixel according to at least one of n original greyscale values of each predetermined color sub-pixel, wherein the n actual greyscale values include a first group of actual greyscale values and a second group of actual greyscale values; (C) in each frame, taking one of the actual greyscale values of each predetermined color sub-pixel as a final greyscale value to drive each predetermined color sub-pixel, wherein, in each frame, with respect to each predetermined color sub-pixel in the predetermined color sub-pixels of a first part, driving one of a first group of actual greyscale values of the predetermined color sub-pixel itself as a final greyscale value, and with respect to each predetermined color sub-pixel in the predetermined color sub-pixels of a second part, driving one of a second group of actual greyscale values of the predetermined color sub-pixel itself as a final greyscale value.

Wherein a step of acquiring n actual greyscale values of the one predetermined color sub-pixel according to at least one of n original greyscale values of any one predetermined color sub-pixel in step (B) includes: determining m index values according to at least one of n original greyscale values of any one predetermined color sub-pixel, m being an integer larger than 0; searching for a actual greyscale values corresponding to each of the m index values in a display look-up table of the predetermined color sub-pixel, so as to acquire n actual greyscale values of the one predetermined color sub-pixel, wherein a×m=n, a first group of actual greyscale values in the n actual greyscale values include at least one of a actual greyscale values corresponding to each index value, a second group of the n actual greyscale values include other actual greyscale values not included in the first group of actual greyscale values in a actual greyscale values corresponding to each index value, and a is an integer larger than 1.

Wherein when a=2, a first group of actual greyscale values in the n actual greyscale values include a relatively larger one of two actual greyscale values corresponding to each index value, and a second group of the n actual greyscale values include a relatively smaller one of two actual greyscale values corresponding to each index value.

Wherein a step of acquiring n actual greyscale values of any one predetermined color sub-pixel according to at least one of n original greyscale values of each predetermined color sub-pixel in step (B) includes: acquiring a first group of actual greyscale values of the one predetermined color sub-pixel according to at least one of n original greyscale values of any one predetermined color sub-pixel; acquiring a second group of actual greyscale values of the one predetermined color sub-pixel according to at least one of n original greyscale values of a predetermined color sub-pixel adjacent to the one predetermined color sub-pixel.

Wherein a step of acquiring a first group of actual greyscale values of the one predetermined color sub-pixel according to at least one of n original greyscale values of any one predetermined color sub-pixel includes: determining m index values according to at least one of n original greyscale values of any one predetermined color sub-pixel, m being an integer larger than 0; searching for a actual greyscale values corresponding to each of the m index values in a display look-up table of the predetermined color sub-pixel, so as to acquire n actual greyscale values; extracting a first group of actual greyscale values from the n actual greyscale values as the first group of actual greyscale values of the one predetermined color sub-pixel, wherein a×m=n, a first group of actual greyscale values in the n actual greyscale values include at least one of a actual greyscale values corresponding to each index value, and a is an integer larger than 1.

Wherein when a=2, a first group of actual greyscale values in the n actual greyscale values include a relatively larger one of two actual greyscale values corresponding to each index value.

Wherein a step of acquiring a second group of actual greyscale values of the one predetermined color sub-pixel according to at least one of n original greyscale values of a predetermined color sub-pixel adjacent to the one predetermined color sub-pixel includes: determining m index values according to at least one of n original greyscale values of the one adjacent predetermined color sub-pixel, m being an integer larger than 0; searching for a actual greyscale values corresponding to each of the m index values in a display look-up table of the predetermined color sub-pixel, so as to acquire n actual greyscale values; extracting a second group of actual greyscale values from the n actual greyscale values as the second group of actual greyscale values of the one predetermined color sub-pixel, wherein a×m=n, a second group of actual greyscale values in the n actual greyscale values include at least one of a actual greyscale values corresponding to each index value, and a is an integer larger than 1.

Wherein when a=2, a second group of actual greyscale values in the n actual greyscale values include a relatively smaller one of two actual greyscale values corresponding to each index value.

Wherein a step of determining m index values includes: taking any m original greyscale values in the n original greyscale values as the m index values.

Wherein a step of determining m index values includes: dividing the n original greyscale values into m groups according to a predetermined rule; determining an index value with respect to each one of the m groups, so as to acquire the m index values.

Wherein a step of determining an index value with respect to any one of the m groups includes: taking an average value of an original greyscale value in the one group as the one index value.

Wherein a step of determining an index value with respect to any one of the m groups includes: determining a brightness value of the one predetermined color sub-pixel when being at respective original greyscale values in the one group; calculating an average value of determined brightness values; taking a greyscale value on the gamma curve corresponding to the average value as the one index value.

Wherein a display look-up table of the predetermined color sub-pixel is acquired through the following step: acquiring an actual brightness value of the predetermined color sub-pixel respectively in a case of front viewing and in a case of obliquely viewing under the respective greyscale value within a greyscale value range of the liquid crystal panel; calculating a theoretical brightness value of the predetermined color sub-pixel respectively in a case of front viewing and in a case of obliquely viewing under the respective greyscale value within the value range; determining a actual greyscale values meeting a predetermined condition and corresponding to each greyscale value within the value range which is taken as an index value based on the acquired respective actual brightness value and the calculated respective theoretical brightness value; acquiring the display look-up table based on a correspondence relationship between each index value and actual greyscale value.

Wherein an actual brightness value of the predetermined color sub-pixel under the respective greyscale value within the greyscale value range of the liquid crystal panel in the case of front viewing and in the case of obliquely viewing is acquired by measuring a gamma curve of the color sub-pixel separately in the case of front viewing and in the case of obliquely viewing.

Wherein a theoretical brightness value of the predetermined color sub-pixel is calculated under any greyscale value g within the greyscale value range in a case of viewing from any angle through the following equation:

Lv(g)=Lv(gₘₐₓ)′×(g/gₘₐₓ)^{γ}

Wherein γ is a predetermined gamma value, Lv(g) is a theoretical brightness value of the predetermined color sub-pixel under the greyscale value g in the case of viewing from the angle, and Lv(gₘₐₓ)′ is the actual brightness values of the predetermined color sub-pixel under the maximum greyscale value gₘₐₓ within the value range in the case of viewing from the angle, wherein viewing from the angle refers to front viewing or obliquely viewing.

Wherein any greyscale value g within the greyscale value range, which is determined by the relationship determining unit and is taken as the index value, as well as two corresponding actual greyscale values g_{H} and g_{L}, meet the following predetermine condition:

min y=[Lv_{front}(g)+Lv_{front}(g)−Lv_{front} (g_{H})′−Lv_{front}(g_{L})′]²+[Lv_{oblique}(g)+Lv_{oblique}(g)−Lv_{oblique}(g_{H})′−Lv_{oblique}(g_{L})′]²

wherein Lv_{front}(g) and Lv_{oblique} (g) are the theoretical brightness value of the color sub-pixel under the greyscale value g separately in the case of front viewing and in the case of obliquely viewing, Lv_{front}(g_{H})′ and Lv_{oblique}(g_{H})′ are the actual brightness value of the color sub-pixel under the actual greyscale value g_{H} separately in the case of front viewing and in the case of obliquely viewing, Lv_{front} (g_{L})′ and Lv_{oblique}(g_{L})′ are the actual brightness value of the color sub-pixel under the actual greyscale value is g_{L} separately in the case of front viewing and in the case of obliquely viewing.

Wherein when n=4, there are two index values, the actual greyscale values g_{H} respectively corresponding to the two index values are g_{H1} and g_{H2} respectively, the actual greyscale values g_{L} respectively corresponding to the two index values are g_{L1} and g_{L2} respectively, then a first group of actual greyscale values in the four actual greyscale values include actual greyscale values g_{H1} and g_{H2}, and a second group of actual greyscale values in the four actual greyscale values include actual greyscale values g_{L1} and g_{L2}.

Wherein each one of the predetermined color sub-pixels in the first part may have the following final greyscale values in four consecutive frames of one unit: g_{H1}, g_{H2}, g_{L1} and g_{L2} of the predetermined color sub-pixel itself, and each one of the predetermined color sub-pixels in the second part may have the following final greyscale values in four consecutive frames of one unit: g_{L1}, g_{L2}, g_{H1} and g_{H2} of the predetermined color sub-pixel itself.

Wherein each one of the predetermined color sub-pixels in the first part may have the following final greyscale values in four consecutive frames of one unit: g_{H1}, g_{L1}, g_{L2} and g_{H2} of the predetermined color sub-pixel itself, and each one of the predetermined color sub-pixels in the second part may have the following final greyscale values in four consecutive frames of one unit: g_{L1}, g_{H2}, g_{H1} and g_{L2} of the predetermined color sub-pixel itself.

Wherein the predetermined color sub-pixel of the first part is the predetermined color sub-pixel in odd number column, and the predetermined color sub-pixel of the second part is the predetermined color sub-pixel in even number column.

Wherein the predetermined color sub-pixel of the first part is the predetermined color sub-pixel of which a sum of a row number and a column number is an even number, and the predetermined color sub-pixel of the second part is the predetermined color sub-pixel of which a sum of a row number and a column number is an odd number.

Wherein the predetermined color sub-pixel of the first part is the predetermined color sub-pixel in odd number row, and the predetermined color sub-pixel of the second part is the predetermined color sub-pixel in even number row.

According to another aspect of an exemplary embodiment of the present disclosure, there is provided a driving device of a liquid crystal panel, characterized in: the driving device drives a predetermined color sub-pixel of a liquid crystal panel in a unit of consecutive n frames, wherein n is an integer larger than 1, and the driving device includes: an original greyscale value determining module, for determining an original greyscale value of each predetermined color sub-pixel respectively in n frames, so as to acquire n original greyscale values with respect to each predetermined color sub-pixel; an actual greyscale value acquiring module, for acquiring n actual greyscale values of each predetermined color sub-pixel according to at least one of n original greyscale values of each predetermined color sub-pixel, wherein the n actual greyscale values include a first group of actual greyscale values and a second group of actual greyscale values; a driving module for driving each predetermined color sub-pixel in each frame by taking one of the actual greyscale values of each predetermined color sub-pixel as a final greyscale value, wherein, in each frame, the driving module drives one of a first group of actual greyscale values of the predetermined color sub-pixel itself as a final greyscale value with respect to each predetermined color sub-pixel in the predetermined color sub-pixels of a first part, and drives one of a second group of actual greyscale values of the predetermined color sub-pixel itself as a final greyscale value with respect to each predetermined color sub-pixel in the predetermined color sub-pixels of a second part.

Wherein an actual greyscale value acquiring module acquires n actual greyscale values of each predetermined color sub-pixel in sequence, wherein the actual greyscale value acquiring module includes: an index value determining unit, for determining m index values according to at least one of n original greyscale values of any one predetermined color sub-pixel, m being an integer larger than 0; a table look-up unit, for searching for a actual greyscale values corresponding to each of the m index values in a display look-up table of the predetermined color sub-pixel, so as to acquire n actual greyscale values of the one predetermined color sub-pixel, wherein a×m=n, a first group of actual greyscale values in the n actual greyscale values include at least one of a actual greyscale values corresponding to each index value, a second group of the n actual greyscale values include other actual greyscale values not included in the first group of actual greyscale values in a actual greyscale values corresponding to each index value, and a is an integer larger than 1.

Wherein when a=2, a first group of actual greyscale values in the n actual greyscale values include a relatively larger one of two actual greyscale values corresponding to each index value, and a second group of the n actual greyscale values include a relatively smaller one of two actual greyscale values corresponding to each index value.

Wherein an actual greyscale value acquiring module acquires n actual greyscale values of each predetermined color sub-pixel in sequence, wherein the actual greyscale value acquiring module includes: a first group of actual greyscale value acquiring units, for acquiring a first group of actual greyscale values of the one predetermined color sub-pixel according to at least one of n original greyscale values of any one predetermined color sub-pixel; a second group of actual greyscale value acquiring units, for acquiring a second group of actual greyscale values of the one predetermined color sub-pixel according to at least one of n original greyscale values of a predetermined color sub-pixel adjacent to the one predetermined color sub-pixel.

Wherein, the first group of actual greyscale value acquiring units include: a first index value determining unit, for determining m index values according to at least one of n original greyscale values of any one predetermined color sub-pixel, m being an integer larger than 0; a first table look-up sub-unit, for searching for a actual greyscale values corresponding to each of the m index values in a display look-up table of the predetermined color sub-pixel, so as to acquire n actual greyscale values; a first group of actual greyscale value extracting sub-units, for extracting a first group of actual greyscale values from the n actual greyscale values as the first group of actual greyscale values of the one predetermined color sub-pixel, wherein a×m=n, a first group of actual greyscale values in the n actual greyscale values include at least one of a actual greyscale values corresponding to each index value, and a is an integer larger than 1.

Wherein when a=2, a first group of actual greyscale values in the n actual greyscale values include a relatively larger one of two actual greyscale values corresponding to each index value.

Wherein, the second group of actual greyscale value acquiring units include: a second index value determination sub-unit, for determining m index values according to at least one of n original greyscale values of the one adjacent predetermined color sub-pixel, m being an integer larger than 0; a second table look-up sub-unit, for searching for a actual greyscale values corresponding to each of the m index values in a display look-up table of the predetermined color sub-pixel, so as to acquire n actual greyscale values; a second group of actual greyscale value extracting sub-units, for extracting a second group of actual greyscale values from the n actual greyscale values as the second group of actual greyscale values of the one predetermined color sub-pixel, wherein a×m=n, a second group of actual greyscale values in the n actual greyscale values include at least one of a actual greyscale values corresponding to each index value, and a is an integer larger than 1.

Wherein when a=2, a second group of actual greyscale values in the n actual greyscale values include a relatively smaller one of two actual greyscale values corresponding to each index value.

Wherein the index value determining unit takes any m original greyscale values in the n original greyscale values as the m index values.

Wherein the index value determining unit includes: a first dividing sub-unit for dividing said n original greyscale values into m groups according to a predetermined rule; a first determining sub-unit for determining an index value with respect to each one of the m groups, so as to acquire the m index values.

Wherein the first determining sub-unit determines in sequence an index value with respect to each one of the m groups, wherein the first determining sub-unit takes an average value of the original greyscale values in any one of the m groups as an index value.

Wherein the first determining sub-unit determines in sequence an index value with respect to each one of the m groups, wherein the first determining sub-unit includes: a first brightness value determining sub-unit, for determining a brightness value of the one predetermined color sub-pixel when being at respective original greyscale values in any one of the m groups; a first average value calculation sub-unit, for calculating an average value of determined brightness values; a first correspondence determining sub-unit, for taking a greyscale value of the average value on the gamma curve as the one index value.

Wherein, the actual greyscale value acquiring module further include: a table creating unit for creating a display look-up table of the predetermined color sub-pixel, wherein the table creating unit includes: an actual brightness value acquiring sub-unit for acquiring actual brightness values of the predetermined color sub-pixel respectively in a case of front viewing and in a case of obliquely viewing under the respective greyscale value within a greyscale value range of the liquid crystal panel; a theoretical brightness value calculation sub-unit for calculating the theoretical brightness values of the predetermined color sub-pixel respectively in a case of front viewing and in a case of obliquely viewing under the respective greyscale value within the value range; a relationship determination sub-unit for determining a actual greyscale values meeting a predetermined condition and corresponding to each greyscale value within the value range which is taken as an index value based on the acquired respective actual brightness value and the calculated respective theoretical brightness value; a creation sub-unit for acquiring the display look-up table based on a correspondence relationship between each index value and actual greyscale value.

Wherein the actual brightness value acquiring unit acquires an actual brightness value of the predetermined color sub-pixel under the respective greyscale value within the greyscale value range of the liquid crystal panel in the case of front viewing and in the case of obliquely viewing by measuring a gamma curve of the color sub-pixel separately in the case of front viewing and in the case of obliquely viewing.

Wherein the theoretical brightness value calculation sub-unit calculates the theoretical brightness values of the predetermined color sub-pixel under any greyscale value g within the greyscale value range in a case of viewing from any angle through the following equation:

Lv(g)=Lv(gₘₐₓ)′×(g/gₘₐₓ)^{γ}

Wherein γ is a predetermined gamma value, Lv(g) is a theoretical brightness value of the predetermined color sub-pixel under the greyscale value g in the case of viewing from the angle, and Lv(gₘₐₓ)′ is the actual brightness values of the predetermined color sub-pixel under the maximum greyscale value gₘₐₓ within the value range in the case of viewing from the angle, wherein viewing from the angle refers to front viewing or obliquely viewing.

Wherein any greyscale value g within the greyscale value range, which is determined by the relationship determining sub-unit and is taken as the index value, as well as two corresponding actual greyscale values g_{H} and g_{L}, meet the following predetermine condition:

min y=[Lv_{front}(g)+Lv_{front}(g)−Lv_{front} (g_{H})′−Lv_{front} (g_{L})′]²+[Lv_{oblique}(g)+Lv_{oblique}(g)−Lv_{oblique}(g_{H})′−Lv_{oblique}(g_{L})′]²

wherein Lv_{front}(g) and Lv_{oblique}(g) are the theoretical brightness value of the color sub-pixel under the greyscale value g separately in the case of front viewing and in the case of obliquely viewing, Lv_{front}(g_{H})′ and Lv_{oblique}(g_{H})′ are the actual brightness value of the color sub-pixel under the actual greyscale value g_{H} separately in the case of front viewing and in the case of obliquely viewing, Lv_{front}(g_{L})′ and Lv_{oblique}(g_{L})′ are the actual brightness value of the color sub-pixel under the actual greyscale value is g_{L} separately in the case of front viewing and in the case of obliquely viewing.

Wherein when n=4, there are two index values, the actual greyscale values g_{H} respectively corresponding to the two index values are g_{H1} and g_{H2} respectively, the actual greyscale values g_{L} respectively corresponding to the two index values are g_{L1} and g_{L2} respectively, then a first group of actual greyscale values in the four actual greyscale values include actual greyscale values g_{H1} and g_{H2}, and a second group of actual greyscale values in the four actual greyscale values include actual greyscale values g_{L1} , and g_{L2}.

Wherein each one of the predetermined color sub-pixels in the first part may have the following final greyscale values in four consecutive frames of one unit: g_{H1}, g_{H2}, g_{L1} and g_{L2} of the predetermined color sub-pixel itself, and each one of the predetermined color sub-pixels in the second part may have the following final greyscale values in four consecutive frames of one unit: g_{L1}, g_{L2}, g_{H1} and g_{H2} of the predetermined color sub-pixel itself.

Wherein each one of the predetermined color sub-pixels in the first part may have the following final greyscale values in four consecutive frames of one unit: g_{H1}, g_{L1}, g_{L2} and g_{H2} of the predetermined color sub-pixel itself, and each one of the predetermined color sub-pixels in the second part may have the following final greyscale values in four consecutive frames of one unit: g_{L2}, g_{H2}, g_{H1} and g_{L1} of the predetermined color sub-pixel itself.

Wherein the predetermined color sub-pixel of the first part is the predetermined color sub-pixel in odd number column, and the predetermined color sub-pixel of the second part is the predetermined color sub-pixel in even number column.

Wherein the predetermined color sub-pixel of the first part is the predetermined color sub-pixel of which a sum of a row number and a column number is an even number, and the predetermined color sub-pixel of the second part is the predetermined color sub-pixel of which a sum of a row number and a column number is an odd number.

Wherein the predetermined color sub-pixel of the first part is the predetermined color sub-pixel in odd number row, and the predetermined color sub-pixel of the second part is the predetermined color sub-pixel in even number row.

Based on the driving method and driving device of the liquid crystal panel provided in an exempary embodiment of the present disclosure, one can correct a picture flickering of the liquid crystal panel while reducing a color bias of the liquid crystal panel.

Other aspects and/or advantages of the present disclosure will be partially illustrated in the following description, and the rests will be clarified through further description or implementation of the present disclosure.

### BRIEF DESCRIPTION OF THE DRAWINGS

These and/or other aspects and advantages of the disclosure will become apparent and more readily appreciated from the following description of the embodiments, taken in conjunction with the accompanying drawings in which:

FIG. 1 is a block diagram illustrating a step of driving predetermined color sub-pixel of n frames of any one unit in a driving method of liquid crystal panel according to an exemplary embodiment of the present disclosure;

FIG. 2 is a block diagram illustrating a step of acquiring n actual greyscale values of the one predetermined color sub-pixel according to at least one of n original greyscale values of any one predetermined color sub-pixel according to an exemplary embodiment of the present disclosure;

FIG. 3 is a block diagram illustrating a step of acquiring a display look-up table of the predetermined color sub-pixel according to exemplary embodiments of the present disclosure;

FIG. 4 is a block diagram illustrating a step of acquiring n actual greyscale values of the any one predetermined color sub-pixel according to at least one of n original greyscale values of each predetermined color sub-pixel according to an exemplary embodiment of the present disclosure;

FIG. 5 is a block diagram illustrating a step of acquiring a first group of actual greyscale values of the one predetermined color sub-pixel according to at least one of n original greyscale values of any one predetermined color sub-pixel according to an exemplary embodiment of the present disclosure;

FIG. 6 is a block diagram illustrating a step of acquiring a second group of actual greyscale values of the one predetermined color sub-pixel according to at least one of n original greyscale values of an adjacent predetermined color sub-pixel of any one predetermined color sub-pixel according to an exemplary embodiment of the present disclosure;

FIG. 7 is a schematic diagram illustrating a greyscale value of a part of the predetermined color sub-pixel in each frame when driving a liquid crystal panel by a unit of four consecutive frames according to an exemplary embodiment of the present disclosure;

FIG. 8 is a schematic diagram illustrating a greyscale value of a part of the predetermined color sub-pixel in each frame when driving a liquid crystal panel by a unit of four consecutive frames according to another exemplary embodiment of the present disclosure;

FIG. 9 is a schematic diagram illustrating a greyscale value of a part of the predetermined color sub-pixel in each frame when driving a liquid crystal panel by a unit of four consecutive frames according to another exemplary embodiment of the present disclosure;

FIG. 10 is a block diagram illustrating a driving device of the liquid crystal panel according to an exemplary embodiment of the present disclosure;

FIG. 11 is a block diagram illustrating an actual greyscale value acquiring module according to an exemplary embodiment of the present disclosure;

FIG. 12 is a block diagram illustrating a table creating unit according to the exemplary embodiment of the present disclosure;

FIG. 13 is a block diagram illustrating an actual greyscale value acquiring module according to another exemplary embodiment of the present disclosure;

FIG. 14 is a block diagram illustrating a first group of actual greyscale value acquiring units according to an exemplary embodiment of the present disclosure;

FIG. 15 is a block diagram illustrating a second group of actual greyscale value acquiring units according to an exemplary embodiment of the present disclosure.

### DETAILED DESCRIPTION OF EXEMPLARY EMBODIMENTS

Here a detailed reference will be made to the exemplary embodiment of the present disclosure, in which the examples are shown in the drawings and the same drawing reference marks may indicate the same component. Embodiments of the present disclosure will be described in detail below by referring to the accompany drawings.

It should be clarified that the liquid crystal panel mentioned herein includes a plurality of pixels, each pixel including sub-pixels of a plurality of colors. The aftermentioned predetermined color sub-pixel refers to the sub-pixel of any one of a plurality of colors in the liquid crystal panel.

An driving method of a liquid crystal panel according to an exemplary embodiment of the present disclosure is characterized in: driving a predetermined color sub-pixel of a liquid crystal panel in a unit of consecutive n frames. Here, n is an integer larger than 1. A step of driving n frames of any one unit of predetermined color sub-pixel is described hereinafter.

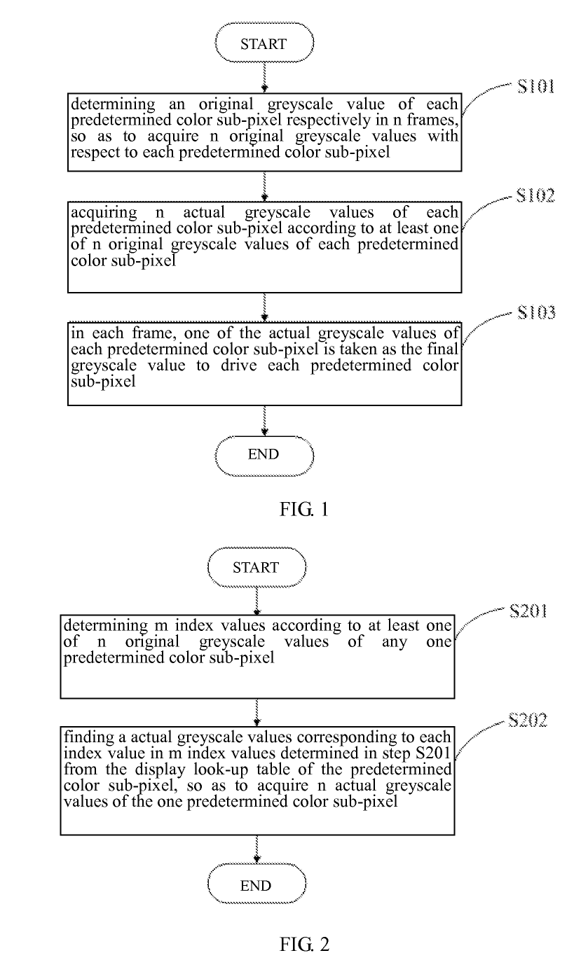

FIG. 1 is a block diagram illustrating a step of driving predetermined color sub-pixel of n frames of any one unit in a driving method of liquid crystal panel according to the exemplary embodiment of the present disclosure.

As shown in FIG. 1, in step S101, determining an original greyscale value of each predetermined color sub-pixel respectively in n frames, so as to acquire n original greyscale values with respect to each predetermined color sub-pixel. Here, the original greyscale value is an initial greyscale value of a frame of picture displayed by the sub-pixel (for example, the greyscale value configured for the sub-pixel when driving the liquid crystal panel to display a frame of picture in the related art). In may be understood that, various existing methods may be used to acquire n original greyscale values of each predetermined color sub-pixel.

In step S102, acquiring n actual greyscale values of each predetermined color sub-pixel according to at least one of n original greyscale values of each predetermined color sub-pixel acquired in step S101. Here, those skilled in the art can acquire the n actual greyscale values by using various existing methods.

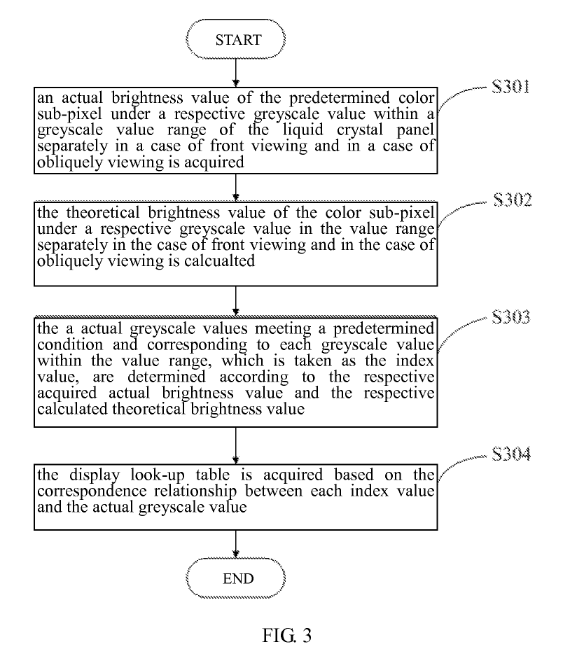

As an example, FIG. 2 shows a step of acquiring n actual greyscale values of the one predetermined color sub-pixel according to at least one of n original greyscale values of any one predetermined color sub-pixel (that is, acquiring n actual greyscale values of the predetermined color sub-pixel itself according to at least one of n original greyscale values of any one of the predetermined color sub-pixel itself).

FIG. 2 is a block diagram illustrating a step of acquiring n actual greyscale values of the one predetermined color sub-pixel according to at least one of n original greyscale values of any one predetermined color sub-pixel according to the exemplary embodiment of the present disclosure.

As shown in FIG. 2, in step S201, determining m index values according to at least one of n original greyscale values of any one predetermined color sub-pixel, m being an integer larger than 0. Here, the index values are the greyscale values for searching the display look-up table as mentioned below. A number of the index values may be determined according to n and the actual greyscale values corresponding to each index value in the aftermentioned display look-up table. In may be understood that, various existing methods may be used to determine the m index values.

As an example, any m original greyscale values in the n original greyscale values may be taken as the m index values.

As another example, the n original greyscale values may be divided into m groups according to a predetermined rule. Here, the predetermined rule may be set by those skilled in the art according to design experiences. Then, an index value is determined with respect to each one of the m groups, so as to acquire the m index values. Here, various methods may be used to determine the index value of each group.

As an example, a step of determining an index value with respect to any one of the m groups includes: taking an average value of an original greyscale value in the one group as the one index value (that is, as the index value of the one group). Specifically speaking, a sum of the respective original greyscale values in the one group is calculated, which is then divided by a number of the original greyscale values in the one group to acquire the average value, and the average value is taken as an index value.

In addition, a step of determining an index value with respect to any one of the m groups includes:

First, determining a brightness value of the one predetermined color sub-pixel when being at respective original greyscale values in the one group according to a gamma curve of the one predetermined color sub-pixel. Here, the gamma curve is a curve indicating the relationship between the greyscale and brightness of the predetermined color sub-pixel, and various measuring methods may be used to acquire the gamma curve. The gamma curve may be a normalized gamma curve, but is not limited thereto, and a gamma curve which has not been normalized can also be used.

Secondly, calculating an average value of determined brightness values, that is, a sum of the brightness values of the one predetermined color sub-pixel when being at respective original greyscale values in the one group is calculated, which is then divided by a number of the original greyscale values in the one group to acquire the average value.

Then, a greyscale value of the average value on the gamma curve is taken as the one index value.

In step S202, finding a actual greyscale values corresponding to each index value in m index values determined in step S201 from the display look-up table of the predetermined color sub-pixel, so as to acquire n actual greyscale values of the one predetermined color sub-pixel, that is, the a actual greyscale values corresponding to each index value in the display look-up table may constitute the n actual greyscale values of the one predetermined color sub-pixel.

Here, a×m=n, a first group of actual greyscale values in the n actual greyscale values include at least one of a actual greyscale values corresponding to each index value, a second group of the n actual greyscale values include other actual greyscale values not included in the first group of actual greyscale values in a actual greyscale values corresponding to each index value, and a is an integer larger than 1.

Here, said display look-up table may be determined through various existing methods. Preferably, FIG. 3 shows the step of acquiring the display look-up table of the predetermined color sub-pixel.

FIG. 3 is a block diagram illustrating a step of acquiring a display look-up table of the predetermined color sub-pixel according to exemplary embodiments of the present disclosure.

As shown in FIG. 3, in step S301, an actual brightness value of the predetermined color sub-pixel under a respective greyscale value within a greyscale value range of the liquid crystal panel separately in a case of front viewing and in a case of obliquely viewing is acquired. Here, front viewing refers to viewing the liquid crystal panel in parallel with a direction perpendicular to the liquid crystal panel. Obliquely viewing refers to viewing the liquid crystal panel from a place in a line so that the angle between the line and the direction perpendicular to the liquid crystal panel is about 60 degree. The value range of the greyscale value may vary along with the liquid crystal panel. When the liquid crystal panel is a 8-bit liquid crystal panel (that is, using a 8-bit binary number to indicate the greyscale value), the value range is [0, 255]; when the liquid crystal panel is a 10-bit liquid crystal panel (that is, using a 10-bit binary to indicate the greyscale value), the value range is [0, 1023]. In may be understood that, various existing methods may be used to acquire the actual brightness value.

As an example, the actual brightness value of the predetermined color sub-pixel under the respective greyscale value within the greyscale value range of the liquid crystal panel in the case of front viewing and in the case of obliquely viewing may be acquired by measuring a gamma curve of the predetermined color sub-pixel separately in the case of front viewing and in the case of obliquely viewing. The gamma curve is a curve indicating a relationship between a greyscale and a brightness of the predetermined color sub-pixel. Here, the gamma curve may be measured through various existing methods.

In step S302, the theoretical brightness value of the color sub-pixel under a respective greyscale value in the value range separately in the case of front viewing and in the case of obliquely viewing is calculated. Here, the theoretical brightness value may be calculated through various existing calculation methods.

As an example, the theoretical brightness value of the predetermined color sub-pixel under any greyscale value g within the value range in a case of viewing from any angle is calculated through the following equation:

Lv(g)=Lv(gₘₐₓ)′×(g/gₘₐₓ)^{γ} (1)

Here, γ is a predetermined gamma value, Lv(g) is the theoretical brightness value of the color sub-pixel under the greyscale value g in the case of viewing from the angle, and Lv(gₘₐₓ)′ is the actual brightness values of the color sub-pixel under the maximum greyscale value gₘₐₓ within the value range in the case of viewing from the angle. Here, the angle refers to front viewing or obliquely viewing.

When calculating the theoretical brightness value of the predetermined color sub-pixel under any greyscale value g within the value range in the case of front viewing, the greyscale value g, the maximum greyscale value gₘₐₓ within the value range and the predetermined gamma value γ are substituted into equation (1), and actual brightness value Lv(gₘₐₓ)′ of the predetermined color sub-pixel under the maximum greyscale value gₘₐₓ in the case of front viewing is substituted, thus obtaining the theoretical brightness value of the predetermined color sub-pixel under the greyscale value g in the case of front viewing. Based on this, the theoretical brightness value of the predetermined color sub-pixel under the respective greyscale value within the value range in the case of front viewing may be calculated.

When calculating the theoretical brightness value of the color sub-pixel under any greyscale value g within the value range in the case of obliquely viewing, the greyscale value g, the maximum greyscale value gₘₐₓ within the value range and the predetermined gamma value γ are substituted into equation (1), and actual brightness value Lv(g)′ of the color sub-pixel under the maximum greyscale value gₘₐₓ in the case of obliquely viewing is substituted, thus obtaining the theoretical brightness value of the color sub-pixel under the greyscale value g in the case of obliquely viewing. Based on this, the theoretical brightness value of the color sub-pixel under the respective greyscale value within the value range in the case of obliquely viewing may be calculated.

Here, the predetermined gamma value γ may be 2.2, but is not limited thereto, which may be set according to an actual situation. For example, the maximum greyscale value gₘₐₓ is a maximum value within the value range, which may be 255 or 1023, but is not limited thereto, which can also be determined according to an actual parameter of the liquid crystal panel.

In step S303, the a actual greyscale values meeting a predetermined condition and corresponding to each greyscale value within the value range, which is taken as the index value, are determined according to the respective actual brightness value acquired in step S301 and the respective theoretical brightness value calculated in step S302, that is, with respect to each greyscale value within the value range, which is taken as the index value, the a actual greyscale values corresponding to the greyscale value may be determined, and the predetermine condition may be met between each greyscale value and the a actual greyscale values. Those skilled in the art may set the predetermined condition according to experiences.

Preferably, any greyscale value g within the greyscale value range, which is taken as the index value, as well as two corresponding actual greyscale values g_{H} and g_{L} meet the following predetermine condition:

min y=[Lv_{front}(g)+Lv_{front}(g)−Lv_{front}(g_{H})′−Lv_{front}(g_{L})′]²+[Lv_{oblique}(g)+Lv_{oblique}(g)−Lv_{oblique}(g_{H})′−Lv_{oblique}(g_{L})′]² (2)

Here, a=2, wherein Lv_{front}(g) and Lv_{oblique}(g) are the theoretical brightness value of the color sub-pixel under the greyscale value g separately in the case of front viewing and in the case of obliquely viewing, Lv_{front} (g_{H})′ and LV_{oblique} (g_{H})′ are the actual brightness value of the color sub-pixel under the actual greyscale value g_{H} separately in the case of front viewing and in the case of obliquely viewing, Lv_{front}(g_{L})′ and Lv_{oblique}(g_{L})′ are the actual brightness value of the color sub-pixel under the actual greyscale value is g_{L} separately in the case of front viewing and in the case of obliquely viewing.

Thus, two actual greyscale values g_{H} and g_{L} corresponding to each index value within the value range and meeting the equation (2) may be determined.

Here, a number of the actual greyscale values corresponding to each index value may be determined according to scenarios of application.

In step S304, the display look-up table is acquired based on the correspondence relationship between each index value and the actual greyscale value within the value range determined in step S303.

Returning to FIG. 2, by using the display look-up table of the predetermined color sub-pixel acquired through the steps as shown in FIG. 3, a actual greyscale values corresponding to each of the m index values determined in step S201 may be found from the display look-up table, so as to acquire a×m=n actual greyscale values of the one predetermined color sub-pixel. Here, a first group of actual greyscale values in the n actual greyscale values include at least one of a actual greyscale values corresponding to each index value, a second group of the n actual greyscale values include other actual greyscale values not included in the first group of actual greyscale values in a actual greyscale values corresponding to each index value, and a is an integer larger than 1.

As an example, when a=2, a first group of actual greyscale values in the n actual greyscale values include a relatively larger one of two actual greyscale values corresponding to each index value, that is, a relatively larger one of two actual greyscale values corresponding to any one of the m index values is taken as one of the first group of actual greyscale values, thereby acquiring the first group of actual greyscale values constituted by m relatively larger actual greyscale values.

A second group of actual greyscale values in the n actual greyscale values include a relatively smaller one of two actual greyscale values corresponding to each index value. That is, a relatively smaller one of two actual greyscale values corresponding to any one of the m index values is taken as one of the second group of actual greyscale values, thereby acquiring the second group of actual greyscale values constituted by m relatively smaller actual greyscale values.

Based on above, the n actual greyscale values of each predetermined color sub-pixel may be acquired by using the method as shown in FIG. 2.

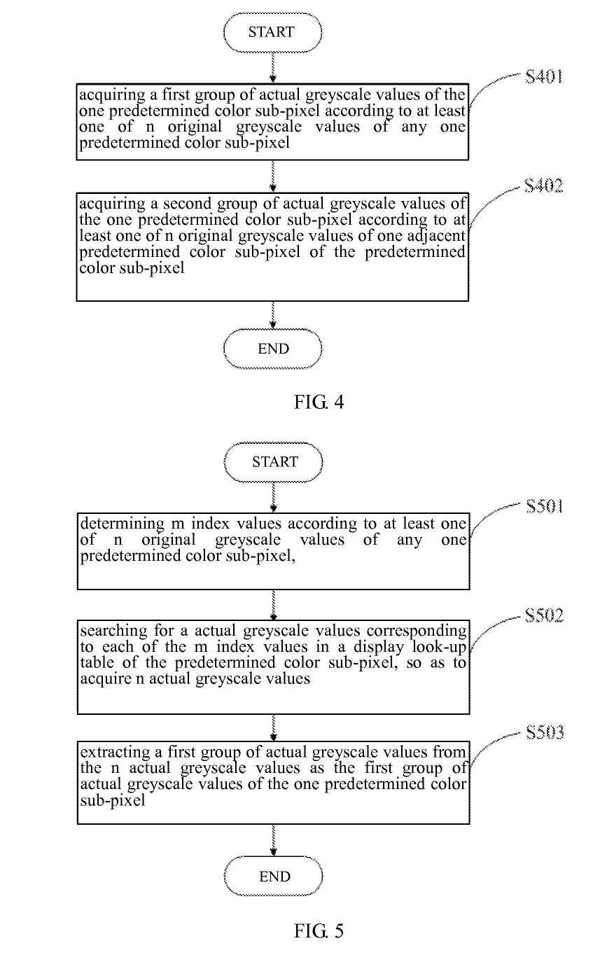

Returning to FIG. 1, regarding step S102, as another example of the method of acquiring n actual greyscale values of any one predetermined color sub-pixel, the step of acquiring n actual greyscale values of any one predetermined color sub-pixel according to at least one of n original greyscale values of each predetermined color sub-pixel acquired in step S101 is as shown in FIG. 4.

FIG. 4 is a block diagram illustrating a step of acquiring n actual greyscale values of the any one predetermined color sub-pixel according to at least one of n original greyscale values of each predetermined color sub-pixel according to the exemplary embodiment of the present disclosure.

As shown in FIG. 4, in step S401, acquiring a first group of actual greyscale values of the one predetermined color sub-pixel according to at least one of n original greyscale values of any one predetermined color sub-pixel (that is, acquiring the first group of actual greyscale values of the predetermined color sub-pixel itself according to at least one of n original greyscale values of the one of the predetermined color sub-pixel itself). Here, the first group of actual greyscale values may be acquired by using various existing methods.

Preferably, the first group of actual greyscale values may be acquired by using a method as shown in FIG. 5.

FIG. 5 is a block diagram illustrating a step of acquiring a first group of actual greyscale values of the one predetermined color sub-pixel according to at least one of n original greyscale values of any one predetermined color sub-pixel according to the exemplary embodiment of the present disclosure.

As shown in FIG. 2, in step S501, determining m index values according to at least one of n original greyscale values of any one predetermined color sub-pixel, m being an integer larger than 0. Step S501 and step S201 both refer to determining m index values according to at least one of n original greyscale values of a predetermined color sub-pixel, thus the methods thereof are identical to each other, and will not be repeated herein.

In step S502, searching for a actual greyscale values corresponding to each of the m index values in a display look-up table of the predetermined color sub-pixel, so as to acquire n actual greyscale values; Here, a is an integer larger than 1. The method of acquiring the look-up table is identical to the one in step S202, and will not be repeated herein.

By using the display look-up table of the predetermined color sub-pixel acquired through the steps as shown in FIG. 3, a actual greyscale values corresponding to each of the m index values determined in step S501 may be found from the display look-up table, so as to acquire a×m=n actual greyscale values.

In step S503, extracting a first group of actual greyscale values from the n actual greyscale values obtained from step S502 as the first group of actual greyscale values of the one predetermined color sub-pixel.

Here, a×m=n, a first group of actual greyscale values in the n actual greyscale values include at least one of a actual greyscale values corresponding to each index value, and a is an integer larger than 1.

As an example, when a=2, a first group of actual greyscale values in the n actual greyscale values include a relatively larger one of two actual greyscale values corresponding to each index value, that is, a relatively larger one of two actual greyscale values corresponding to any one of the m index values is taken as one of the first group of actual greyscale values, thereby acquiring the first group of actual greyscale values constituted by m relatively larger actual greyscale values.

Returning to FIG. 4, in step S402, acquiring a second group of actual greyscale values of the one predetermined color sub-pixel according to at least one of n original greyscale values of one adjacent predetermined color sub-pixel of the predetermined color sub-pixel (that is, the second group of actual greyscale value of the one predetermined color sub-pixel itself are acquired according to at least one of n original greyscale values of the adjacent one predetermined color sub-pixel).

Here, the one adjacent predetermined color sub-pixel of the one predetermined color sub-pixel may be any one of the plurality of predetermined color sub-pixels adjacent to the one predetermined color sub-pixel, and can also be any one predetermined color sub-pixel other than the one predetermined color sub-pixel in the liquid crystal panel. Those skilled in the art may choose an adjacent predetermined color sub-pixel according to experiences. It may be understood that, the second group of actual greyscale values may be acquired by using various existing methods.

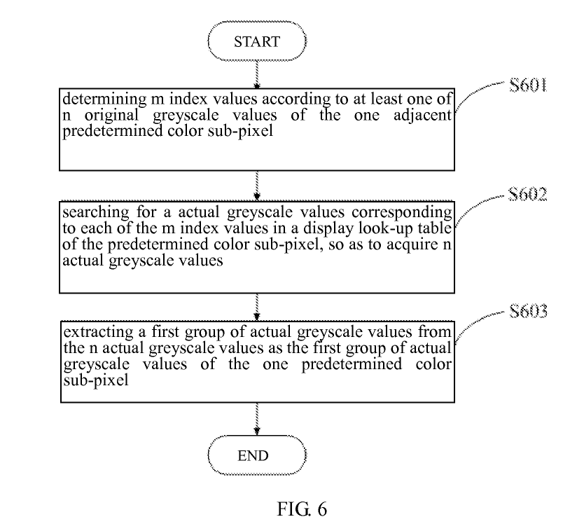

Preferably, the second group of actual greyscale values may be acquired by using a method as shown in FIG. 6.

FIG. 6 is a block diagram illustrating a step of acquiring a second group of actual greyscale values of the one predetermined color sub-pixel according to at least one of n original greyscale values of an adjacent predetermined color sub-pixel of any one predetermined color sub-pixel according to the exemplary embodiment of the present disclosure.

As shown in FIG. 2, in step S601, determining m index values according to at least one of n original greyscale values of the one adjacent predetermined color sub-pixel, m being an integer larger than 0. Here, various existing methods may be used to determine the m index values.

As an example, any m original greyscale values in the n original greyscale values of the one adjacent predetermined color sub-pixel may be taken as the m index values.

As another example, the n original greyscale values of the one adjacent predetermined color sub-pixel may be divided into m groups according to a predetermined rule. Here, the predetermined rule may be set by those skilled in the art according to design experiences. Then, an index value is determined with respect to each one of the m groups, so as to acquire the m index values. Here, various methods may be used to determine the index value of each group.

As an example, a step of determining an index value with respect to any one of the m groups includes: taking an average value of an original greyscale value in the one group as the one index value (that is, as the index value of the one group). Specifically speaking, a sum of the respective original greyscale values in the one group is calculated, which is then divided by a number of the original greyscale values in the one group to acquire the average value, and the average value is taken as an index value.

In addition, a step of determining an index value with respect to any one of the m groups includes:

First, determining a brightness value of the one adjacent predetermined color sub-pixel when being at respective original greyscale values in the one group according to a gamma curve of the one adjacent predetermined color sub-pixel. Here, the gamma curve is a curve indicating the relationship between the greyscale and brightness of the one adjacent predetermined color sub-pixel, and various measuring methods may be used to acquire the gamma curve. The gamma curve may be a normalized gamma curve, but is not limited thereto, and a gamma curve which has not been normalized can also be used.

Secondly, calculating an average value of determined brightness values, that is, a sum of the brightness values of the one adjacent predetermined color sub-pixel when being at respective original greyscale values in the one group is calculated, which is then divided by a number of the original greyscale values in the one group to acquire the average value.

Then, a greyscale value of the average value on the gamma curve is taken as the one index value.

In step S602, searching for a actual greyscale values corresponding to each of the m index values in a display look-up table of the predetermined color sub-pixel, so as to acquire n actual greyscale values. Here, a is an integer larger than 1. The method of acquiring the look-up table is identical to the one in step S202 and step S502, and will not be repeated herein.

By using the display look-up table of the predetermined color sub-pixel acquired through the steps as shown in FIG. 3, a actual greyscale values corresponding to each of the m index values determined in step S601 may be found from the display look-up table, so as to acquire a×m=n actual greyscale values.

In step S603, extracting a first group of actual greyscale values from the n actual greyscale values obtained from step S602 as the first group of actual greyscale values of the one predetermined color sub-pixel.

Here, a×m=n, a second group of actual greyscale values in the n actual greyscale values include at least one of a actual greyscale values corresponding to each index value, and a is an integer larger than 1.

As an example, when a=2, a second group of actual greyscale values in the n actual greyscale values include a relatively smaller one of two actual greyscale values corresponding to each index value, that is, a relatively smaller one of two actual greyscale values corresponding to any one of the m index values is taken as one of the second group of actual greyscale values, thereby acquiring the second group of actual greyscale values constituted by m relatively smaller actual greyscale values.

The first group of actual greyscale value acquired by using the method of FIG. 5 and the second group of actual greyscale values acquired by using the method of FIG. 6 together constitute the n actual greyscale values of the one predetermined color sub-pixel.

Returning to FIG. 1, in step S103, in each frame, one of the actual greyscale values of each predetermined color sub-pixel is taken as the final greyscale value to drive each predetermined color sub-pixel. Here, an actual greyscale value of any one predetermined color sub-pixel in each frame in n consecutive frames of one unit is a different actual greyscale value. That is, the n actual greyscale values of each predetermined color sub-pixel acquired in step S102 are respectively taken as the final greyscale values when each predetermined color sub-pixel displays each frame of one unit. Here, the final greyscale value refers to a greyscale value of a sub-pixel during a final display of a liquid crystal panel.

Here, in each frame, one of the first actual greyscale values of the predetermined color sub-pixel itself is driven as the final greyscale value with respect to each one of the predetermined color sub-pixel of the first part, and one of the second actual greyscale values of the predetermined color sub-pixel itself is driven as the final greyscale value with respect to each one of the predetermined color sub-pixel of the second part, that is, the predetermined color sub-pixels in the liquid crystal panel are divided into two parts, each predetermined color sub-pixel belonging to the first part is driven based on one of the actual greyscale values belonging to the first group in the n actual greyscale values of the predetermined color sub-pixel itself, and each predetermined color sub-pixel belonging to the second part is driven based on one of the actual greyscale values belonging to the second group in the n actual greyscale values of the predetermined color sub-pixel itself.

As an example, when n=4 and n=2, m=2, that is, there are two index values, and according to equation (2), the actual greyscale values g_{H} respectively corresponding to the two index values are g_{H1} and g_{H2} respectively, the actual greyscale values g_{L} respectively corresponding to the two index values are g_{L1} and g_{L2} respectively, then a first group of actual greyscale values in the four actual greyscale values include actual greyscale values g_{H1} and g_{H2}, and a second group of actual greyscale values in the four actual greyscale values include actual greyscale values g_{L1} and g_{L2}.

Here, the four actual greyscale values of each predetermined color sub-pixel in four consecutive frames of one unit are g_{H1}, g_{H2}, g_{L1} and g_{L2} respectively. When driving the liquid crystal panel to display each of the four consecutive frames, one of a first group of actual greyscale values g_{H1} and g_{H2} of the predetermined color sub-pixel itself is driven as a final greyscale value with respect to each predetermined color sub-pixel in the predetermined color sub-pixels of a first part, and one of a second group of actual greyscale values g_{L1} and g_{L2} of the predetermined color sub-pixel itself is driven as a final greyscale value with respect to each predetermined color sub-pixel in the predetermined color sub-pixels of a second part.

In an example, the final greyscale values in four consecutive frames of one unit of each one of the predetermined color sub-pixels of the first part may be the actual greyscale values g_{H1}, g_{H2}, g_{L1} and g_{L2} of the predetermined color sub-pixel itself, and the final greyscale values in the four consecutive frames of each one of the predetermined color sub-pixels of the second part may be the actual greyscale values g_{L1}, g_{L2}, g_{H1} and g_{H2} of the predetermined color sub-pixel itself.

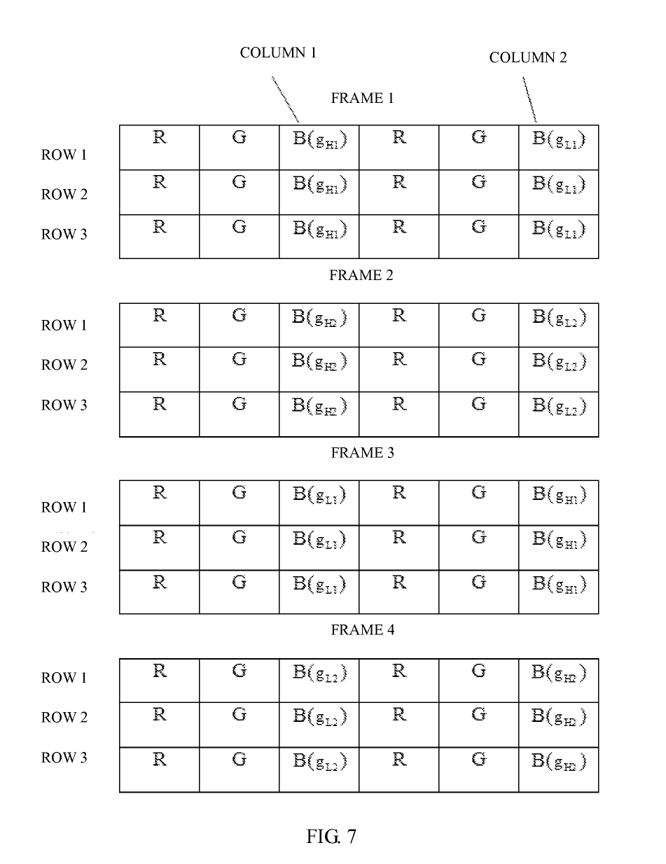

The first part and second part may be any two different parts in the liquid crystal panel. In order to further improve the display effect of the liquid crystal panel, as a preferable example, the predetermined color sub-pixel of the first part may be the predetermined color sub-pixel in odd number column, and the predetermined color sub-pixel of the second part may be the predetermined color sub-pixel in even number column, as shown in FIG. 7.

FIG. 7 is a schematic diagram illustrating a greyscale value of a part of the blue color sub-pixel in each frame when driving a liquid crystal panel by a unit of four consecutive frames according to the exemplary embodiment of the present disclosure. As an example, FIG. 7 only shows 3 rows×2 columns of pixels in the liquid crystal panel, each pixel including an R sub-pixel (i.e. a red sub-pixel), a G sub-pixel (i.e. a green sub-pixel) and a B sub-pixel (i.e. a blue sub-pixel) respectively. Here, the blue sub-pixel will be taken as an example. The parentheses in each blue sub-pixel indicates a ginal greyscale value of the blue sub-pixel at corresponding position. As shown in FIG. 7, the final greyscale values in four consecutive frames of one unit of each blue sub-pixel in the first column are the actual greyscale values g_{H1}, g_{H2}, g_{L1} and g_{L2} of the blue sub-pixel itself, and the final greyscale values in four consecutive frames of one unit of each blue sub-pixel in the second column are the actual greyscale values g_{L1}, g_{L2}, g_{H1} and g_{H2} of the blue sub-pixel itself.

As another preferred embodiment, the predetermined color sub-pixel of the first part is the predetermined color sub-pixel of which a sum of a row number and a column number is an even number, and the predetermined color sub-pixel of the second part is the predetermined color sub-pixel of which a sum of a row number and a column number is an odd number, as shown in FIG. 8.

FIG. 8 is a schematic diagram illustrating a greyscale value of a part of the blue color sub-pixel in each frame when driving a liquid crystal panel by a unit of four consecutive frames according to another exemplary embodiment of the present disclosure. The meanings of respective symbols in FIG. 8 are identical with those in FIG. 7, thus will not be described any more. As shown in FIG. 8, the final greyscale values in four consecutive frames of one unit of each blue sub-pixel in [row 1, column 1], [row 2, column 2] and [row 3, column 1] are the actual greyscale values g_{H1}, g_{H2}, g_{L1} and g_{L2} of the blue sub-pixel itself, and the final greyscale values in four consecutive frames of one unit of each blue sub-pixel in [row 1, column 2], [row 2, column 1] and [row 3, column 2] are the actual greyscale values g_{L1}, g_{L2}, g_{H1} and g_{H2} of the blue sub-pixel itself.

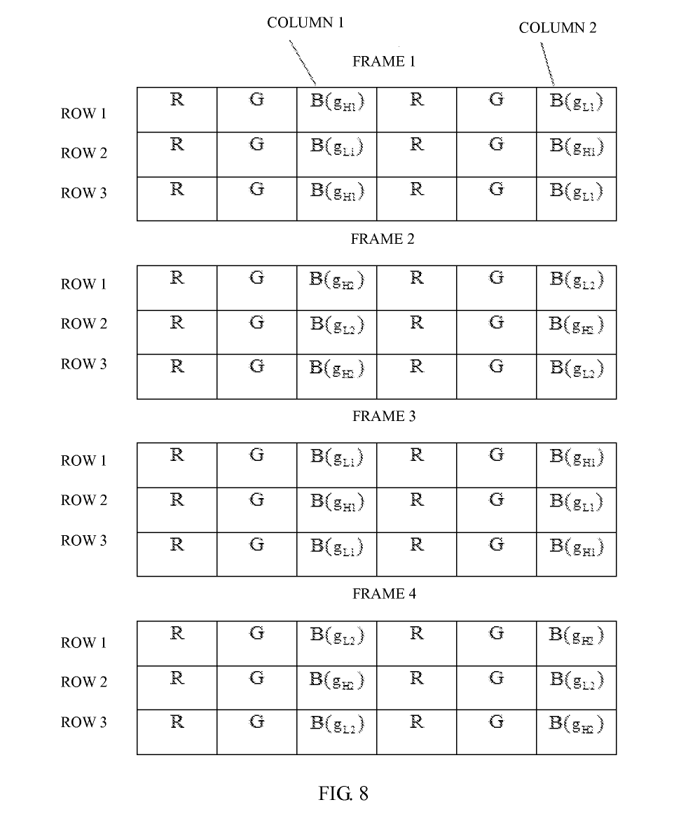

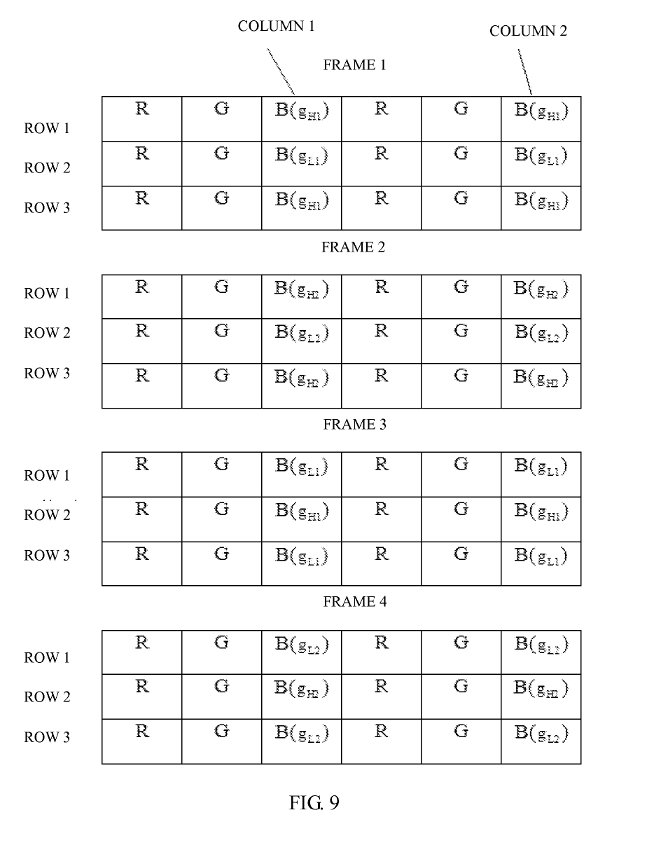

As another preferred example, the predetermined color sub-pixel of the first part is the predetermined color sub-pixel in odd number row, and the predetermined color sub-pixel of the second part is the predetermined color sub-pixel in even number row, as shown in FIG. 9.

FIG. 9 is a schematic diagram illustrating a greyscale value of a part of the blue color sub-pixel in each frame when driving a liquid crystal panel by a unit of four consecutive frames according to another exemplary embodiment of the present disclosure. The meanings of respective symbols in

FIG. 9 are identical with those in FIG. 7 and FIG. 8, thus will not be described any more. As shown in FIG. 9, the final greyscale values in four consecutive frames of one unit of each blue sub-pixel in the first row and the third row are the actual greyscale values g_{H1}, g_{H2}, g_{L1} and g_{L2} of the blue sub-pixel itself, and the final greyscale values in four consecutive frames of one unit of each blue sub-pixel in the second row are the actual greyscale values g_{L1}, g_{L2}, g_{H1} and g_{H2} of the blue sub-pixel itself.

It can be understood that, the exemplary embodiments of the present disclosure are not only limited to the pixels 3 rows x 2 columns as shown in FIGS. 7, 8 and 9, but are also applicable in a scenario where there are larger number of pixels.

In another example, the final greyscale values in four consecutive frames of one unit of each one of the predetermined color sub-pixels of the first part can be g_{H1}, g_{L1}, g_{L2} and g_{H2} of the predetermined color sub-pixel itself, and the final greyscale values in the four consecutive frames of each one of the predetermined color sub-pixels of the second part can be g_{L2}, g_{H2}, g_{H1} and g_{L1} of the predetermined color sub-pixel itself.

The first part and second part can be any two different parts in the liquid crystal panel. In order to further improve the display effect of the liquid crystal panel, the first part and the second part can be divided according to the aforementioned preferred example.

According to the driving method of the liquid crystal panel in the exemplary embodiment of the present disclosure, when the liquid crystal panel displays each frame of picture, in each frame, one of a first group of actual greyscale values and of the predetermined color sub-pixel itself is driven as a final greyscale value with respect to each predetermined color sub-pixel in the predetermined color sub-pixels of a first part, and one of a second group of actual greyscale values and of the predetermined color sub-pixel itself is driven as a final greyscale value with respect to each predetermined color sub-pixel in the predetermined color sub-pixels of a second part, thereby preventing each frame of picture displayed by the liquid crystal panel from being too bright or too dark as a whole, thus solving the problem of flickering of the liquid crystal panel.

Furthermore, the display effect of the liquid crystal panel can be further improved by dividing the first part and the second part of the liquid crystal panel specifically.

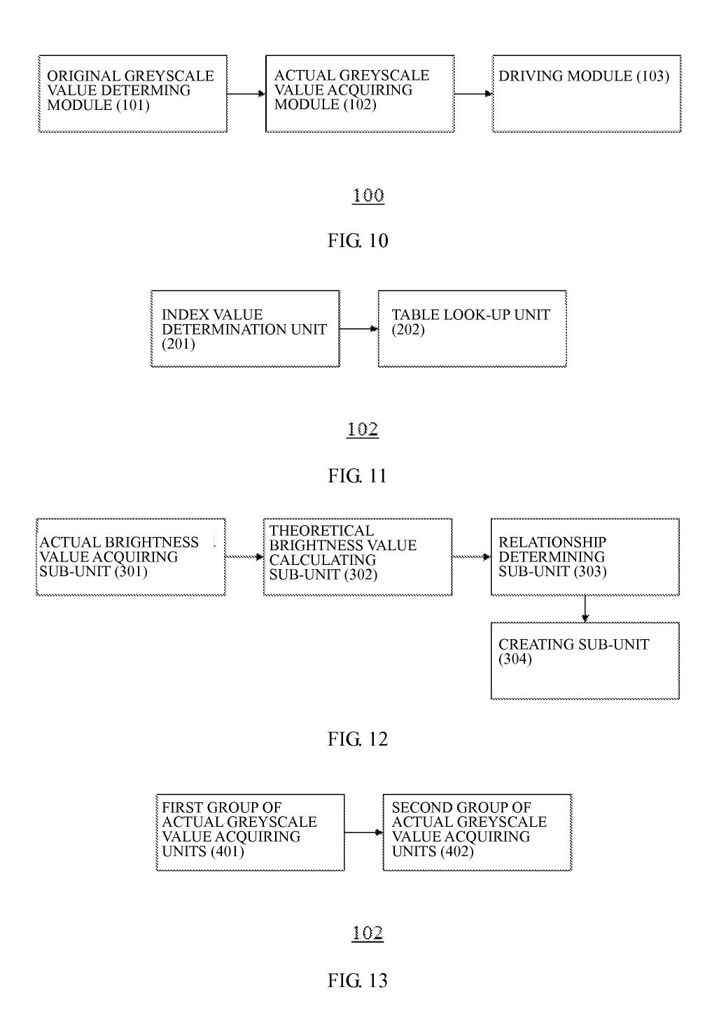

FIG. 10 is a block diagram illustrating the driving apparatus of the liquid crystal panel according to the exemplary embodiment of the present disclosure. Here the driving device of the liquid crystal panel drives the predetermined color sub-pixel of the liquid crystal panel in a unit of n consecutive frames. Wherein, n is an integer larger than 1. It can be understood that, when displaying a video picture, the liquid crystal panel may consecutively display all the frames of the video picture in sequence. In an exemplary embodiment of the present disclosure, the driving device drives each unit of n consecutive frames in sequence, and it can be understood that, a first frame in each unit is connected with an end frame of a previous unit.

As shown in FIG. 10, a driving device 100 of the liquid crystal panel according to the exemplary embodiment of the present disclosure includes: an original greyscale value determining module 101, an actual greyscale value acquiring module 102 and a driving module 103.

the original greyscale value determining module 101 is used for determining an original greyscale value of each predetermined color sub-pixel respectively in n frames, so as to acquire n original greyscale values with respect to each predetermined color sub-pixel. Here, the original greyscale value is an initial greyscale value of a frame of picture displayed by the sub-pixel (for example, the greyscale value configured for the sub-pixel when driving the liquid crystal panel to display a frame of picture in the related art). In can be understood that, the original greyscale value determining module 101 may acquire n original greyscale values of each predetermined color sub-pixel through various existing methods.

The actual greyscale value acquiring module 102 is configured to acquire n actual greyscale values of each predetermined color sub-pixel according to at least one of n original greyscale values of each predetermined color sub-pixel acquired by the original greyscale value determining module 101. Here, the actual greyscale value is the actual greyscale value of the sub-pixel for displaying a frame of picture. It can be understood that, the actual greyscale value acquiring module 102 can acquire the n actual greyscale values by using various existing methods.

Here, the n actual greyscale values include a first group of actual greyscale values and a second group of actual greyscale values. That is, the n actual greyscale values are divided into two groups.

Here, the actual greyscale value acquiring module 102 can acquire n actual greyscale values of each predetermined color sub-pixel in sequence.

FIG. 11 is a block diagram illustrating an actual greyscale value acquiring module according to an exemplary embodiment of the present disclosure.

As an example, as shown in FIG. 11, the actual greyscale value acquiring module 102 includes: an index value determination unit 201 and a table look-up unit 202.

an index value determining unit 201, for determining m index values according to at least one of n original greyscale values of any one predetermined color sub-pixel, m being an integer larger than 0. Here, the index values are the greyscale values for searching the display look-up table as mentioned below. A number of the index values may be determined according to n and the actual greyscale values corresponding to each index value in the aftermentioned display look-up table. In can be understood that, the index value determining unit 201 can be used to determine the m index values through various existing methods.

As an example, the index value determining unit 201 can take any m original greyscale values in the n original greyscale values as the m index values.

As another example, the index value determining unit 201 may include: a first grouping sub-unit and a first determining sub-unit.

The first grouping sub-unit is used for dividing said n original greyscale values into m groups. Here, the predetermined rule can be set by those skilled in the art according to design experiences.

The first determining sub-unit is used for determining an index value with respect to each one of the m groups divided by the first grouping sub-unit, so as to acquire the m index values. Here, the first determining sub-unit may determine the index value of each group through various methods.

Here, the first determining sub-unit can determine an index value with respect to each one of the m groups, so as to acquire the m index values.

In this case, the first determining sub-unit can take an average value of an original greyscale value in any one of the m groups as the one index value (that is, as an index value of the one group). Specifically speaking, a sum of the respective original greyscale values in the one group is calculated, which is then divided by a number of the original greyscale values in the one group to acquire the average value, and the average value is taken as an index value.

In addition, the first determining sub-unit may further include: a first brightness value determining sub-unit, a first average value calculating sub-unit and a first correspondence determining sub-unit.

a first brightness value determining sub-unit, for determining a brightness value of the one predetermined color sub-pixel when being at respective original greyscale values in any one of the m groups. Here, the gamma curve is a curve indicating the relationship between the greyscale and brightness of the predetermined color sub-pixel, and the first brightness value determining sub-unit may acquire the gamma curve through various measuring methods. The gamma curve can be a normalized gamma curve, but is not limited thereto, and a gamma curve which has not been normalized can also be used.

The first average value calculating sub-unit is configured to calculate an average value of brightness values determined by the first brightness value determining sub-unit, that is, a sum of the brightness values of the one predetermined color sub-pixel when being at respective original greyscale values in the one group is calculated, which is then divided by a number of the original greyscale values in the one group to acquire the average value.

The first correspondence determining sub-unit takes a greyscale value on the gamma curve corresponding to the average value as the one index value.

The table look-up unit 202 included in the actual greyscale value acquiring module 102 is configured to find a actual greyscale values corresponding to each index value in m index values determined by the index value determining unit 201 from the display look-up table of the predetermined color sub-pixel, so as to acquire n actual greyscale values of the one predetermined color sub-pixel, that is, the a actual greyscale values corresponding to each index value in the display look-up table may constitute the n actual greyscale values of the one predetermined color sub-pixel.

Here, a×m=n, a first group of actual greyscale values in the n actual greyscale values include at least one of a actual greyscale values corresponding to each index value, a second group of the n actual greyscale values include other actual greyscale values not included in the first group of actual greyscale values in a actual greyscale values corresponding to each index value, and a is an integer larger than 1.

Here, the display look-up table can be a table pre-stored at a predetermined position of the driving device 100 of the liquid crystal panel, or a table created by a specific unit. When using a specific unit to create the display look-up table, the actual greyscale value acquiring module 102 may also include: a table creating unit for creating a display look-up table of the predetermined color sub-pixel. It can be understood that, the table creating unit may create the display look-up table for the sub-pixel of any one color.

It can be understood that, the table creating unit may create the display look-up table of the predetermined color sub-pixel through various existing methods.

FIG. 12 is a block diagram illustrating a table creating unit according to an exemplary embodiment of the present disclosure.

Preferably, as shown in FIG. 12, the table creating unit includes: an actual brightness value acquiring sub-unit 301, a theoretical brightness value calculating sub-unit 302, a relationship determining sub-unit 303 and a creating sub-unit 304.

The actual brightness value acquiring sub-unit 301 is used for acquiring actual brightness values of the predetermined color sub-pixel respectively in a case of front viewing and in a case of obliquely viewing under the respective greyscale value within a greyscale value range of the liquid crystal panel. Here, front viewing refers to viewing the liquid crystal panel in parallel with a direction perpendicular to the liquid crystal panel. Obliquely viewing refers to viewing the liquid crystal panel from a place in a line so that the angle between the line and the direction perpendicular to the liquid crystal panel is about 60 degree. The value range of the greyscale value may vary along with the liquid crystal panel. When the liquid crystal panel is a 8-bit liquid crystal panel (that is, using a 8-bit binary number to indicate the greyscale value), the value range is [0, 255]; when the liquid crystal panel is a 10-bit liquid crystal panel (that is, using a 10-bit binary to indicate the greyscale value), the value range is [0, 1023]. In can be understood that, the actual brightness value acquiring sub-unit 301 can acquire the actual brightness value through various existing methods.

As an example, the actual brightness value acquiring sub-unit 301 can acquire the actual brightness value of the predetermined color sub-pixel under the respective greyscale value within the greyscale value range of the liquid crystal panel in the case of front viewing and in the case of obliquely viewing by measuring a gamma curve of the predetermined color sub-pixel separately in the case of front viewing and in the case of obliquely viewing. The gamma curve is a curve indicating a relationship between a greyscale and a brightness of the predetermined color sub-pixel. Here, the actual brightness value acquiring sub-unit 301 may measure the gamma curve through various existing methods.

The theoretical brightness value calculating sub-unit 302 is used for calculating the theoretical brightness values of the predetermined color sub-pixel respectively in a case of front viewing and in a case of obliquely viewing under the respective greyscale value within the value range. Here, the theoretical brightness value calculating sub-unit 302 may calculate the theoretical brightness value through various existing calculation methods.

As an example, the theoretical brightness value calculating sub-unit 302 may calculate the theoretical brightness value of the predetermined color sub-pixel under any greyscale value g within the greyscale value range in a case of viewing from any angle, so as to calculate the theoretical brightness value of the predetermined color sub-pixel under the respect greyscale values within the value range in a case of front viewing, and the theoretical brightness value of the predetermined color sub-pixel under the respect greyscale values within the value range in a case of oblique viewing.

The relationship determining sub-unit 303 is configured to determine a actual greyscale values meeting predetermined conditions and corresponding to each greyscale value within the value range, which is taken as the index value, according to the respective actual brightness value acquired by the actual brightness value acquiring sub-unit 301 and the respective theoretical brightness value calculated by the theoretical brightness value calculating sub-unit 302, that is, with respect to each greyscale value within the value range, which is taken as the index value, a actual greyscale values corresponding to the greyscale value may be determined, and the predetermine condition can be met between each greyscale value and the a actual greyscale values. Those skilled in the art may set the predetermined condition according to experiences.

Preferably, any greyscale value g within the value range, which is taken as the index value and is determined by the relationship determining sub-unit, and the corresponding actual greyscale values g_{H} and g_{L} may meet the above equation (2).

Thus, two actual greyscale values g_{H} and g_{L} corresponding to each index value within the value range and meeting the equation (2) may be determined.

Here, a number of the actual greyscale values corresponding to each index value can be determined according to scenarios of application.

The creating sub-unit 304 is configured to acquire said display look-up table based on the correspondence relationship between each index value and actual greyscale value within the value range, which may be determined by the relationship determining sub-unit 303.

By using the display look-up table of the predetermined color sub-pixel created by the table creating unit, a actual greyscale values corresponding to each of the m index values determined by the index value determining unit 201 may be found from the display look-up table, so as to acquire a×m=n actual greyscale values of the one predetermined color sub-pixel. Here, a first group of actual greyscale values in the n actual greyscale values include at least one of a actual greyscale values corresponding to each index value, a second group of the n actual greyscale values include other actual greyscale values not included in the first group of actual greyscale values in a actual greyscale values corresponding to each index value, and a is an integer larger than 1.

As an example, when a=2, a first group of actual greyscale values in the n actual greyscale values include a relatively larger one of two actual greyscale values corresponding to each index value, that is, a relatively larger one of two actual greyscale values corresponding to any one of the m index values is taken as one of the first group of actual greyscale values, thereby acquiring the first group of actual greyscale values constituted by m relatively larger actual greyscale values.

A second group of actual greyscale values in the n actual greyscale values include a relatively smaller one of two actual greyscale values corresponding to each index value. That is, a relatively smaller one of two actual greyscale values corresponding to any one of the m index values is taken as one of the second group of actual greyscale values, thereby acquiring the second group of actual greyscale values constituted by m relatively smaller actual greyscale values.

FIG. 13 is a block diagram illustrating an actual greyscale value acquiring module according to another exemplary embodiment of the present disclosure.

As another example, as shown in FIG. 13, the actual greyscale value acquiring module 102 includes: a first group of actual greyscale value acquiring units 401 and a second group of actual greyscale value acquiring units 402.

The first group of actual greyscale value acquiring units is configured to acquire a first group of actual greyscale values of the one predetermined color sub-pixel according to at least one of n original greyscale values of any one predetermined color sub-pixel (that is, acquiring the first group of actual greyscale values of the predetermined color sub-pixel itself according to at least one of n original greyscale values of the one of the predetermined color sub-pixel itself). Here, the first group of actual greyscale value acquiring units 401 may acquire the first group of actual greyscale values by using various existing methods.

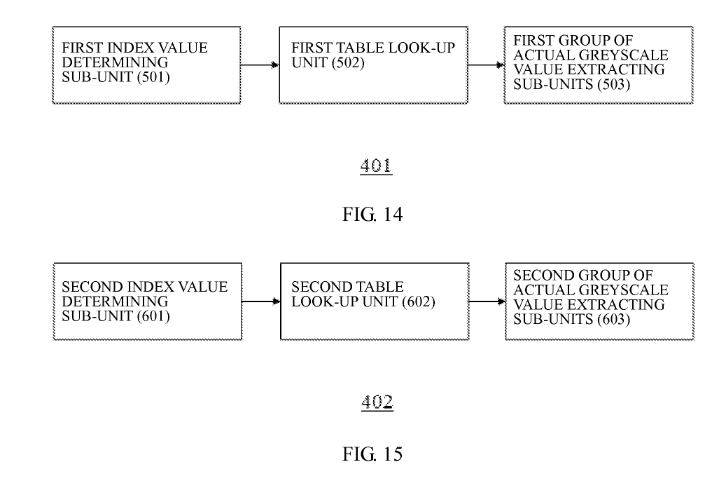

FIG. 14 is a block diagram illustrating a first group of actual greyscale value acquiring units according to an exemplary embodiment of the present disclosure.

Preferably, as shown in FIG. 14, the first group of actual greyscale value acquiring units 401 may include: a first index value determining sub-unit 501, a first table look-up unit 502, and a first group of actual greyscale value extracting sub-units 503.

Here, the first index value determining unit 501 is configured for determining m index values according to at least one of n original greyscale values of any one predetermined color sub-pixel. The first index value determining sub-unit 501 mentioned herein is identical with the index value determining unit 201 in the previous embodiment, thus will not be described any more.

The first table look-up sub-unit 502 is configured for searching for a actual greyscale values corresponding to each of the m index values in a display look-up table of the predetermined color sub-pixel, so as to acquire n actual greyscale values. The first table look-up sub-unit 502 mentioned herein differs from the table look-up unit 202 in the previous embodiment in that: the acquired n actual greyscale values are not taken as n actual greyscale values of the one predetermined color sub-pixel.

Here, the display look-up table can be a table pre-stored at a predetermined position of the driving device 100 of the liquid crystal panel, or a table created by a specific unit. When using a specific unit to create said display look-up table, the first group of actual greyscale value acquisition units 401 may also include: a table creating unit for creating a display look-up table of the predetermined color sub-pixel. It can be understood that, the table creating unit may create the display look-up table for the sub-pixel of any one color. The table creating unit mentioned herein is identical with the table creating unit in the previous embodiment, thus will not be described any more.

The first group of actual greyscale value extracting sub-units 503 are configured for extracting a first group of actual greyscale values from the n actual greyscale values acquired from the first table look-up sub-unit 502 as the first group of actual greyscale values of the one predetermined color sub-pixel.

Here, a×m=n, a first group of actual greyscale values in the n actual greyscale values include at least one of a actual greyscale values corresponding to each index value, and a is an integer larger than 1.

As an example, when a=2, a first group of actual greyscale values in the n actual greyscale values include a relatively larger one of two actual greyscale values corresponding to each index value, that is, a relatively larger one of two actual greyscale values corresponding to any one of the m index values is taken as one of the first group of actual greyscale values, thereby acquiring the first group of actual greyscale values constituted by m relatively larger actual greyscale values.

The second group of actual greyscale value acquiring units 402 are configured for acquiring a second group of actual greyscale values of the one predetermined color sub-pixel according to at least one of n original greyscale values of a predetermined color sub-pixel adjacent to the one predetermined color sub-pixel (that is, the second group of actual greyscale values of the one predetermined color sub-pixel itself are acquired according to at least one of n original greyscale values of a predetermined color sub-pixel adjacent to the one predetermined color sub-pixel).

Here, the one adjacent predetermined color sub-pixel of the one predetermined color sub-pixel can be any one of the plurality of predetermined color sub-pixels adjacent to the one predetermined color sub-pixel, and can also be any one predetermined color sub-pixel other than the one predetermined color sub-pixel in the liquid crystal panel. Those skilled in the art may choose to configure the adjacent predetermined color sub-pixel according to experiences. It can be understood that, the second group of actual greyscale value acquiring units 402 may acquire the second group of actual greyscale values by using various existing methods.

FIG. 15 is a block diagram illustrating a second group of actual greyscale value acquiring units according to an exemplary embodiment of the present disclosure.

Preferably, as shown in FIG. 15, the second group of actual greyscale value acquiring units 402 may include: a second index value determining sub-unit 601, a second table look-up unit 602, and a second group of actual greyscale value extracting sub-units 603.

the second index value determination sub-unit 601 is configured for determining m index values according to at least one of n original greyscale values of the one adjacent predetermined color sub-pixel, m being an integer larger than 0.

In can be understood that, the second index value determining unit 601 can be used to determine the m index values through various existing methods.

As an example, the second index value determining sub-unit 601 may take any m original greyscale values in the n original greyscale values of the one adjacent predetermined color sub-pixel as the m index values.

As another example, the second index value determining sub-unit 601 may include: a second grouping sub-unit and a second determining sub-unit.

The second grouping sub-unit is configured for dividing said n original greyscale values of the one adjacent predetermined color sub-pixel into m groups according to a predetermine rule. Here, the predetermined rule can be set by those skilled in the art according to design experiences.

The second determining sub-unit is used for determining an index value with respect to each one of the m groups divided by the second grouping sub-unit, so as to acquire the m index values. Here, the second determining sub-unit may determine the index value of each group through various methods.

Here, the second determining sub-unit can determine an index value with respect to each one of the m groups, so as to acquire the m index values.

In this case, the second determining sub-unit can take an average value of an original greyscale value in any one of the m groups as the one index value (that is, as an index value of the one group). Specifically speaking, a sum of the respective original greyscale values in the one group is calculated, which is then divided by a number of the original greyscale values in the one group to acquire the average value, and the average value is taken as an index value.

In addition, the second determining sub-unit may further include: a second brightness value determining sub-unit, a second average value calculating sub-unit and a second correspondence determining sub-unit.

The second brightness value determining sub-unit is configured for determining a brightness value of the one adjacent predetermined color sub-pixel when being at respective original greyscale values in any one of the m groups according to a gamma curve of the one adjacent predetermined color sub-pixel. Here, the gamma curve is a curve indicating the relationship between the greyscale and brightness of the one adjacent predetermined color sub-pixel, and the second brightness value determining sub-unit may acquire the gamma curve through various measuring methods. The gamma curve can be a normalized gamma curve, but is not limited thereto, and a gamma curve which has not been normalized can also be used.

The second average value calculating sub-unit is used to calculate an average value of brightness values determined by the second brightness value determining sub-unit, that is, a sum of the brightness values of the one adjacent predetermined color sub-pixel when being at respective original greyscale values in the one group is calculated, which is then divided by a number of the original greyscale values in the one group to acquire the average value.

The second correspondence determining sub-unit takes a greyscale value on the gamma curve corresponding to the average value calculated by the second average value calculating sub-unit as the one index value.

The second table look-up unit 602 included in the second group of actual greyscale value acquiring units 402 is configured for searching for a actual greyscale values corresponding to each of the m index values in a display look-up table of the predetermined color sub-pixel, so as to acquire n actual greyscale values.

Here, the display look-up table can be a table pre-stored at a predetermined position of the driving device 100 of the liquid crystal panel, or a table created by a specific unit. When using a specific unit to create said display look-up table, the second group of actual greyscale value acquisition units 402 may also include: a table creating unit for creating a display look-up table of the predetermined color sub-pixel. It can be understood that, the table creating unit may create the display look-up table for the sub-pixel of any one color. The table creating unit mentioned herein is identical with the table creating unit in the previous embodiment, thus will not be described any more.

The second group of actual greyscale value extracting sub-units 603 are configured for extracting a second group of actual greyscale values from the n actual greyscale values acquired from the first table look-up sub-unit 602 as the second group of actual greyscale values of the one predetermined color sub-pixel.

Here, a×m=n, a second group of actual greyscale values in the n actual greyscale values include at least one of a actual greyscale values corresponding to each index value, and a is an integer larger than 1.

As an example, when a=2, a second group of actual greyscale values in the n actual greyscale values include a relatively smaller one of two actual greyscale values corresponding to each index value, that is, a relatively smaller one of two actual greyscale values corresponding to any one of the m index values is taken as one of the second group of actual greyscale values, thereby acquiring the second group of actual greyscale values constituted by m relatively smaller actual greyscale values.

The first group of actual greyscale values acquired by the first group of actual greyscale value acquiring units 401 and the second group of actual greyscale values acquired by the second group of actual greyscale value acquiring units 402 together constitute the n actual greyscale values of the one predetermined color sub-pixel.

The driving module 103 is configured for taking one of the actual greyscale values of each predetermined color sub-pixel as the final greyscale value to drive each predetermined color sub-pixel in each frame. Here, an actual greyscale value of any one predetermined color sub-pixel in each frame in n consecutive frames of one unit is a different actual greyscale value. That is, the n actual greyscale values of each predetermined color sub-pixel acquired by the actual greyscale value acquiring module 102 are respectively taken as the final greyscale values when each predetermined color sub-pixel displays each frame of one unit. Here, the final greyscale value refers to a greyscale value of a sub-pixel during a final display of a liquid crystal panel.

Here, in each frame, the driving module 103 drives one of the first actual greyscale values of oneself is as the final greyscale value with respect to each one of the predetermined color sub-pixel of the first part, and the driving module 103 drives one of the second actual greyscale values of oneself as the final greyscale value with respect to each one of the predetermined color sub-pixel of the second part, that is, the driving module 103 divides the predetermined color sub-pixels in the liquid crystal panel into two parts, each predetermined color sub-pixel belonging to the first part is driven based on one of the actual greyscale values belonging to the first group in the n actual greyscale values of the predetermined color sub-pixel itself, and each predetermined color sub-pixel belonging to the second part is driven based on one of the actual greyscale values belonging to the second group in the n actual greyscale values of the predetermined color sub-pixel itself.

As an example, when n=4 and n=2, m=2, that is, there are two index values, and according to equation (2), the actual greyscale values g_{H} respectively corresponding to the two index values are g_{H1} and g_{H2} respectively, the actual greyscale values g_{L} respectively corresponding to the two index values are g_{L1} and g_{L2} respectively, then a first group of actual greyscale values in the four actual greyscale values include actual greyscale values g_{H1}, and g_{H2}, and a second group of actual greyscale values in the four actual greyscale values include actual greyscale values g_{L1} and g_{L2}.

Here, the four actual greyscale values of each predetermined color sub-pixel in four consecutive frames of one unit are g_{H1}, g_{L1}, g_{H2} and g_{L2} respectively. When driving the liquid crystal panel to display each of the four consecutive frames, one of a first group of actual greyscale values g_{H1} , and g_{H2} of the predetermined color sub-pixel itself is driven as a final greyscale value with respect to each predetermined color sub-pixel in the predetermined color sub-pixels of a first part, and one of a second group of actual greyscale values g₁ and g_{L2} of the predetermined color sub-pixel itself is driven as a final greyscale value with respect to each predetermined color sub-pixel in the predetermined color sub-pixels of a second part.

In an example, the final greyscale values in four consecutive frames of one unit of each one of the predetermined color sub-pixels of the first part may be the actual greyscale values g_{H1}, g_{H2}, g_{L1} and g_{L 2} of the predetermined color sub-pixel itself, and the final greyscale values in the four consecutive frames of each one of the predetermined color sub-pixels of the second part may be the actual greyscale values g_{L1}, g_{L2}, g_{H1} and g_{H2} of the predetermined color sub-pixel itself.

The first part and second part may be any two different parts in the liquid crystal panel. In order to further improve the display effect of the liquid crystal panel, as a preferable example, the predetermined color sub-pixel of the first part may be the predetermined color sub-pixel in odd number column, and the predetermined color sub-pixel of the second part may be the predetermined color sub-pixel in even number column.

As another preferred embodiment, the predetermined color sub-pixel of the first part is the predetermined color sub-pixel of which a sum of a row number and a column number is an even number, and the predetermined color sub-pixel of the second part is the predetermined color sub-pixel of which a sum of a row number and a column number is an odd number.

As another preferred example, the predetermined color sub-pixel of the first part is the predetermined color sub-pixel in odd number row, and the predetermined color sub-pixel of the second part is the predetermined color sub-pixel in even number row.

In another example, the final greyscale values in four consecutive frames of one unit of each one of the predetermined color sub-pixels of the first part can be g_{H1}, g_{L1}, g_{L2} and g_{H2} of the predetermined color sub-pixel itself, and the final greyscale values in the four consecutive frames of each one of the predetermined color sub-pixels of the second part can be g_{L2}, g_{H2}, g_{H1} and g_{L1} of the predetermined color sub-pixel itself.

The first part and second part may be any two different parts in the liquid crystal panel. In order to further improve the display effect of the liquid crystal panel, the first part and the second part can be divided according to the aforementioned preferred example.

According to the driving device of the liquid crystal panel in the exemplary embodiment of the present disclosure, when the liquid crystal panel displays each frame of picture, in each frame, the driving module 103 may drive one of a first group of actual greyscale values and of the predetermined color sub-pixel itself as a final greyscale value with respect to each predetermined color sub-pixel in the predetermined color sub-pixels of a first part, and may drive one of a second group of actual greyscale values and of the predetermined color sub-pixel itself as a final greyscale value with respect to each predetermined color sub-pixel in the predetermined color sub-pixels of a second part, thereby preventing each frame of picture displayed by the liquid crystal panel from being too bright or too dark as a whole, thus solving the problem of flickering of the liquid crystal panel.

Furthermore, the display effect of the liquid crystal panel can be further improved by dividing the first part and the second part of the liquid crystal panel specifically.

In addition, the above method in the embodiment of the present disclosure can also be embodied as computer readable codes on a computer readable recording medium. Those skilled in the art may implement the computer codes according to the description for the above method. When the computer codes are performed in a computer, the above method of the present disclosure is implemented.

In addition, each unit in the driving apparatus of the liquid crystal panel in accordance with the exemplary embodiment of the present disclosure can be implemented to be hardware components. Those skilled in the art may implement respective units by using, for example, field-programmable gate array (FPGA) or application-specific integrated circuit (ASIC), according to the processes performed by respective defined units.

The above embodiments of the present disclosure are only exemplary embodiments, and the present disclosure is not limited to said examples. Those skilled in the art may know that: The exemplary embodiments can be changed without deviating from the principle and idea of the present disclosure, wherein, the scope of the present disclosure is defined in the claims and the equivalents thereof.

1. A driving method of a liquid crystal panel, including: driving a predetermined color sub-pixel of a liquid crystal panel in a unit of consecutive n frames, wherein n is an integer larger than 1, and a step of driving a predetermined color sub-pixel in n frames of any one unit includes:
(A) determining an original greyscale value of each predetermined color sub-pixel respectively in n frames, so as to acquire n original greyscale values with respect to each predetermined color sub-pixel;
(B) acquiring n actual greyscale values of each predetermined color sub-pixel according to at least one of n original greyscale values of each predetermined color sub-pixel, wherein the n actual greyscale values include a first group of actual greyscale values and a second group of actual greyscale values;
(C) taking one of the actual greyscale values of each predetermined color sub-pixel as the final greyscale value to drive each predetermined color sub-pixel in each frame,
wherein taking one of the first group of actual greyscale values of the predetermined color sub-pixel itself as the final greyscale value to perform the driving in each frame with respect to each one of the predetermined color sub-pixels of the first part,
and taking one of the second group of actual greyscale values of the predetermined color sub-pixel itself as the final greyscale value to perform the driving with respect to each one of the predetermined color sub-pixels of the second part.

2. The driving method of claim 1, wherein a step of acquiring n actual greyscale values of the one predetermined color sub-pixel according to at least one of n original greyscale values of any one predetermined color sub-pixel in step (B) includes:
determining m index values according to at least one of n original greyscale values of any one predetermined color sub-pixel, m being an integer larger than 0;
searching for a actual greyscale values corresponding to each of the m index values in a display look-up table of the predetermined color sub-pixel, so as to acquire n actual greyscale values of the one predetermined color sub-pixel,
wherein a×m=n, a first group of actual greyscale values in the n actual greyscale values include at least one of a actual greyscale values corresponding to each index value, a second group of the n actual greyscale values include other actual greyscale values not included in the first group of actual greyscale values in a actual greyscale values corresponding to each index value, and a is an integer larger than 1.

3. The driving method of claim 2, wherein when a=2, a first group of actual greyscale values in the n actual greyscale values include a relatively larger one of two actual greyscale values corresponding to each index value,
a second group of actual greyscale values in the n actual greyscale values include a relatively smaller one of two actual greyscale values corresponding to each index value.

4. The driving method of claim 1, wherein a step of acquiring n actual greyscale values of any one predetermined color sub-pixel according to at least one of n original greyscale values of each predetermined color sub-pixel in step (B) includes:
acquiring a first group of actual greyscale values of the one predetermined color sub-pixel according to at least one of n original greyscale values of any one predetermined color sub-pixel;
acquiring a second group of actual greyscale values of the one predetermined color sub-pixel according to at least one of n original greyscale values of a predetermined color sub-pixel adjacent to the one predetermined color sub-pixel.

5. The driving method of claim 2, wherein a display look-up table of the predetermined color sub-pixel is acquired through the following step:
acquiring an actual brightness value of the predetermined color sub-pixel respectively in a case of front viewing and in a case of obliquely viewing under the respective greyscale value within a greyscale value range of the liquid crystal panel;
calculating a theoretical brightness value of the predetermined color sub-pixel respectively in a case of front viewing and in a case of obliquely viewing under the respective greyscale value within the value range;
determining a actual greyscale values meeting a predetermined condition and corresponding to each greyscale value within the value range which is taken as an index value based on the acquired respective actual brightness value and the calculated respective theoretical brightness value;
acquiring the display look-up table based on a correspondence relationship between each index value and actual greyscale value.

6. A driving device of a liquid crystal panel, wherein the driving device drives a predetermined color sub-pixel of a liquid crystal panel in a unit of consecutive n frames, wherein n is an integer larger than 1, and the driving device includes:
an original greyscale value determining module, for determining an original greyscale value of each predetermined color sub-pixel respectively in n frames, so as to acquire n original greyscale values with respect to each predetermined color sub-pixel;
an actual greyscale value acquiring module, for acquiring n actual greyscale values of each predetermined color sub-pixel according to at least one of n original greyscale values of each predetermined color sub-pixel, wherein the n actual greyscale values include a first group of actual greyscale values and a second group of actual greyscale values;
a driving module for taking one of the actual greyscale values of each predetermined color sub-pixel as the final greyscale value to drive each predetermined color sub-pixel in each frame,
wherein the driving module takes one of the first group of actual greyscale values of the predetermined color sub-pixel itself as the final greyscale value to perform the driving in each frame with respect to each one of the predetermined color sub-pixels of the first part,
and the driving module takes one of the second group of actual greyscale values of the predetermined color sub-pixel itself as the final greyscale value to perform the driving with respect to each one of the predetermined color sub-pixels of the second part.

7. The driving device of claim 6, wherein an actual greyscale value acquiring module acquires n actual greyscale values of each predetermined color sub-pixel in sequence,
wherein the actual greyscale value acquiring module includes:
an index value determining unit, for determining m index values according to at least one of n original greyscale values of any one predetermined color sub-pixel, m being an integer larger than 0;
a table look-up unit for searching for a actual greyscale values corresponding to each of the m index values in a display look-up table of the predetermined color sub-pixel, so as to acquire n actual greyscale values of the one predetermined color sub-pixel,
wherein a×m=n, a first group of actual greyscale values in the n actual greyscale values include at least one of a actual greyscale values corresponding to each index value, a second group of the n actual greyscale values include other actual greyscale values not included in the first group of actual greyscale values in a actual greyscale values corresponding to each index value, and a is an integer larger than 1.

8. The driving device of claim 7, wherein when a=2, a first group of actual greyscale values in the n actual greyscale values include a relatively larger one of two actual greyscale values corresponding to each index value,
a second group of actual greyscale values in the n actual greyscale values include a relatively smaller one of two actual greyscale values corresponding to each index value.

9. The driving device of claim 6, wherein an actual greyscale value acquiring module acquires n actual greyscale values of each predetermined color sub-pixel in sequence,
wherein the actual greyscale value acquiring module includes:
a first group of actual greyscale value acquiring units, for acquiring a first group of actual greyscale values of the one predetermined color sub-pixel according to at least one of n original greyscale values of any one predetermined color sub-pixel;
a second group of actual greyscale value acquiring units, for acquiring a second group of actual greyscale values of the one predetermined color sub-pixel according to at least one of n original greyscale values of a predetermined color sub-pixel adjacent to the one predetermined color sub-pixel.

10. The driving device of claim 7, wherein the actual greyscale value acquiring module further includes: a table creating unit for creating a display look-up table of the predetermined color sub-pixel,
wherein the table creating unit includes:
an actual brightness acquiring sub-unit for acquiring actual brightness values of the predetermined color sub-pixel respectively in a case of front viewing and in a case of obliquely viewing under the respective greyscale value within a greyscale value range of the liquid crystal panel;
a theoretical brightness value calculation sub-unit for calculating the theoretical brightness values of the predetermined color sub-pixel respectively in a case of front viewing and in a case of obliquely viewing under the respective greyscale value within the value range;
a relationship determination sub-unit for determining a actual greyscale values meeting a predetermined condition and corresponding to each greyscale value within the value range which is taken as an index value based on the acquired respective actual brightness value and the calculated respective theoretical brightness value;
a creation sub-unit for acquiring the display look-up table based on a correspondence relationship between each index value and actual greyscale value.
